(19) United States
(12) Patent Application Publication
(10) Pub. No.: US 2021/0379627 A1
(43) Pub. Date: Dec. 9, 2021

(54) GRILL COOKING GRATE CLEANING DEVICE AND SYSTEM FOR CLEANING A COOKING GRATE

(71) Applicant: Todd Kujala, Lake in the Hills, IL (US)

(72) Inventor: Todd Kujala, Lake in the Hills, IL (US)

(21) Appl. No.: 17/406,519

(22) Filed: Aug. 19, 2021

Related U.S. Application Data
(63) Continuation-in-part of application No. 17/206,837, filed on Mar. 19, 2021.
(60) Provisional application No. 62/991,787, filed on Mar. 19, 2020.

(51) Int. Cl. B08B 1/02; A47J 37/07; B08B 1/00; B08B 3/02; B08B 3/04; B08B 3/08; B08B 5/04; B08B 15/04; B08B 7/04; A46B 13/00; A46B 13/02

(52) U.S. Cl. CPC B08B 1/02; A47J 37/0786; B08B 1/002; B08B 3/022; B08B 3/041; A46B 2200/3073; B08B 5/043; B08B 15/04; B08B 7/04; A46B 13/001; A46B 13/02; B08B 3/08

(57) ABSTRACT

A device and system for easily cleaning the cooking grate of a barbeque grill. Specifically, the present disclosure relates to a cleaning device and system for cleaning, degreasing, and sanitizing an entire cooking grate, including the top cooking surface, and opposing underside surface of the grate, which is often missed or ineffectively cleaned by traditional methods.

### CROSS-REFERENCE TO RELATED APPLICATIONS

The present invention claims priority to U.S. patent application Ser. No. 17/206,837, titled “Grill Cooking Grate Cleaning Device and System for Cleaning a Cooking Grate,” filed Mar. 19, 2021, which claims priority to U.S. Provisional Pat. App. No. 62/991,787, titled “Grill Cooking Grate Cleaning Device and System for Cleaning a Cooking Grate,” filed Mar. 19, 2020, each of which is incorporated herein by reference in its entirety.

### TECHNICAL FIELD

The present disclosure relates to a device and system for easily cleaning the cooking grate of a barbeque grill. Specifically, the present disclosure relates to an automated device and system for cleaning, degreasing, and sanitizing an entire cooking grate, including the top cooking surface and opposing underside surface of the grate. The present cleaning device and system provides a more effective method for cleaning, degreasing, and sanitizing a barbeque cooking grate over standard manual cleaning methods.

### BACKGROUND

Cooking food over a grill is a popular activity. Gas grills are commonly used for their ease and efficiency. Food items to be cooked are generally placed directly on a flat horizontal grill grate inside the grill and positioned above the heat source. The grill grate is typically constructed from metals, such as steel, alloy or iron, provided in the shape of bars or rods arranged in a parallel, spaced apart configuration. The spacing of the grill grate permits heat and flames to reach the food, while ensuring that the food does not fall into the fire.

It is inherent that during the cooking process juices, fat and other cooking byproducts will fall through the grill grate, and onto the fire source below. Many of these byproducts are burned off during the cooking process. However, some cooking byproducts, whether fat or grease from high fat content foods, marinades, or other seasonings can cause a buildup of residue not only on the top cooking surface of the grate, but also on the underside surface of the bars of the grate. Although some of the residue may be burned off through high heat of the grill, sometimes residue remains and simply becomes baked onto the grate. Not only can this buildup lead to potential flareups of flames during subsequent cooking, which may ruin or impart undesirable flavors to the food currently on the grill, but the residue may also contain bacteria which could potentially cross-contaminate the new food.

Although there are many tools (brushes, scrapers) and sprays useful for cleaning the top surface of the grill grate, these tools may not be effective for efficiently cleaning the entire grate, including the underside surfaces. Abrasive tools, such as brushes, are frequently used at the beginning of the cooking process and before the grill is heated. Sometimes the brush is used after the cooking is completed, while the grill is still warm. Another option is that the grill is heated at a very high temperature in an attempt to burn off any remaining cooking byproducts. Even with these cleaning methods, however, residue buildup can still occur on the top and underside surfaces of the grate, which may lead to flare-ups, odors, smoke, and potential contamination of subsequently cooked items. As well, brushes, scrapers and other cleaning tools are not always used properly or often enough to completely clean the cooking grate. Additionally, it is not easy to reach the underside of the grill grate without removing it from the inside of the grill.

In view of the above, it would be desirable to provide an easy cleaning option for cleaning the entire cooking grate of a barbeque grill. Additionally, it would be desirable to provide a cleaning device and system for easily cleaning the entire cooking grate, both the top cooking surface and underside surfaces of the grate, without requiring abrasive cleaning tools or sprays. Finally, it would be desirable to provide an automatic cleaning device and system for cleaning the entire surface, top and underside of the cooking grate with ease.

A need, therefore, exists for an improved device and system for easily and effectively cleaning the cooking grate of a barbeque grill. Specifically, a need exists for an improved automated device and system for cleaning, degreasing, and sanitizing an entire cooking grate, including the top cooking surface and opposing underside surface of the grate.

Moreover, a need exists for an improved device and system for easily and effectively cleaning the top and underside surfaces of a cooking grate of a barbeque grill without the use of abrasive tools and sprays.

A need further exists for an improved device and system for easily and effectively cleaning the top and underside surfaces of a cooking grate of a barbeque grill using an automated cleaning device.

### SUMMARY

The present disclosure relates to an improved device and system for easily cleaning the cooking grate of a barbeque grill. Specifically, the present disclosure relates to an automated device and system for cleaning, degreasing, and sanitizing an entire cooking grate from a barbeque grill, including the top cooking surface and opposing underside surface of the cooking grate.

To this end, in an embodiment of the present disclosure, an apparatus for cleaning a cooking grate of a barbeque grill is provided. The apparatus comprises: a chamber for receiving a cooking grate, the chamber having an interior space for receiving a cooking grate; and a first cleaning brush within the chamber, wherein the first cleaning brush is configured to contact and clean at least one surface of the cooking grate within the chamber.

In an embodiment, the first cleaning brush rotates.

In an embodiment, the apparatus further comprises: an entry opening on a first side of the chamber, wherein the cooking grate is configured to enter the chamber through the entry opening.

In an embodiment, the apparatus further comprises: an exit opening on a second side of the chamber opposite the first side of the chamber, wherein the cooking grate is configured to exit the chamber through the exit opening.

In an embodiment, the first cleaning brush is configured to clean the cooking grate as the cooking grate is disposed within the chamber.

In an embodiment, the apparatus further comprises: a second cleaning brush within the chamber.

In an embodiment, the first cleaning brush is disposed beneath the cooking grate as the cooking grate is disposed within the chamber and wherein the second cleaning brush is disposed above the cooking grate as the cooking grate is disposed within the chamber.

In an embodiment, the first cleaning brush and the second cleaning brush are disposed adjacent each other on the same side of a cooking grate as the cooking grate passes through the chamber.

In an embodiment, the apparatus further comprises: a roller for moving the cooking grate through the chamber.

In an embodiment, the roller rotates in a direction to move the cooking grate through the chamber, and wherein the first cleaning brush rotates in a second direction opposite the roller.

In an embodiment, the apparatus further comprises: at least one sprayer or spray nozzle disposed within the chamber for discharging cleaning liquid onto the grate as the cooking grate is disposed within the chamber.

In an embodiment, the apparatus further comprises: a cleaning solution sprayed from the at least one sprayer or spray nozzle onto the cooking grate as the cooking grate is disposed within the chamber.

In an embodiment, the apparatus further comprises: a rinsing solution sprayed from the at least one sprayer or spray nozzle onto the cooking grate as the cooking grate is disposed within the chamber.

In an embodiment, the apparatus further comprises: a first sprayer or spray nozzle disposed within the chamber; and a second sprayer or spray nozzle disposed within the chamber, wherein the first sprayer or spray nozzle is configured to spray a cleaning solution onto the cooking grate as the cooking grate is disposed within the chamber, and the second sprayer or spray nozzle is configured to spray a rinsing solution onto the cooking grate as the cooking grate is disposed within the chamber.

In an embodiment, the apparatus further comprises: a cleaning solution within the chamber.

In an embodiment, the first cleaning brush rotates within the cleaning solution and moves the cleaning solution to the cooking grate as the cooking grate is disposed within the chamber.

In an embodiment, the apparatus further comprises: a collection chamber configured to collect material cleaned from the cooking grate.

In an embodiment, the apparatus further comprises: a vacuum hose connected to the chamber, wherein the vacuum hose is configured to be connected to a vacuum for removing material from the chamber.

In an embodiment, the apparatus further comprises: a side opening in the chamber, wherein the side opening is configured to allow a portion of a grate to pass through the entry opening and the exit opening.

In an embodiment, the chamber is defined by a base, a lid and a hinge between the base and the lid, wherein the cooking grate sits between the lid and the base when cleaned therein.

It is, therefore, an advantage and objective of the present disclosure to provide an improved device and system for easily and effectively cleaning the top and underside surfaces of a cooking grate of a barbeque grill.

It is yet another advantage and objective of the present disclosure to provide an improved device and system for easily and effectively cleaning the top and underside surfaces of a cooking grate of a barbeque grill without abrasive tools and sprays.

It is a further advantage and objective of the present disclosure to provide an improved device and system for easily and effectively cleaning the top and underside surfaces of a cooking grate of a barbeque grill using an automated cleaning chamber.

Additional features and advantages of the present invention are described in, and will be apparent from, the detailed description of the present embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A-1B illustrates an improved cleaning apparatus for cleaning barbeque grates in an embodiment of the present invention.

FIG. 2 illustrates a perspective view of a barbeque grill comprising an improved cleaning device therein in an embodiment of the present invention.

FIG. 3 illustrates a cut-away side view of a grate cleaning apparatus in an embodiment of the present invention.

FIG. 4 illustrates a cut-away side view of a grate cleaning apparatus in an alternate embodiment of the present invention.

FIG. 5 illustrates a perspective view of a grate cleaning apparatus in an alternate embodiment of the present invention.

FIG. 6 illustrates a perspective view of a grate cleaning apparatus in an alternate embodiment of the present invention.

FIG. 7 illustrates a cut-away side view of a grate cleaning apparatus in an alternate embodiment of the present invention.

FIG. 8 illustrates a perspective view of a hand-held grate cleaning apparatus in an alternate embodiment of the present invention.

FIG. 9 illustrates a bottom view of a hand-held grate cleaning apparatus in an alternate embodiment of the present invention.

FIG. 10 illustrates a top view of a hand-held grate cleaning apparatus cleaning a grate in an alternate embodiment of the present invention.

FIG. 11 illustrates a side view of a hand-held grate cleaning apparatus in an alternate embodiment of the present invention.

FIG. 12 illustrates a front view of a rotatable cleaning brush for a grate cleaning apparatus in an embodiment of the present invention.

FIG. 13 illustrates a front perspective view of a tool cart comprising a grill grate cleaning unit, vacuum, and toolbox in an embodiment of the present invention.

### DETAILED DESCRIPTION

The present disclosure relates to an improved device and system for easily cleaning the cooking grate of a barbeque grill. Specifically, the present disclosure relates to an automated cleaning device and system for cleaning, degreasing, and sanitizing an entire cooking grate from a barbeque grill, including the top cooking surface and opposing underside surface of the cooking grate. The present device and system provide a more efficient and effective way to clean both the top and underside surfaces of the grate, without the need for brushes, scrapers, or other abrasive products. Cleaning the cooking grate, whether before or after the grilling process can be a laborious task. The present cleaning device and system easily and effectively completes this task, providing an improved method over traditional cleaning methods.

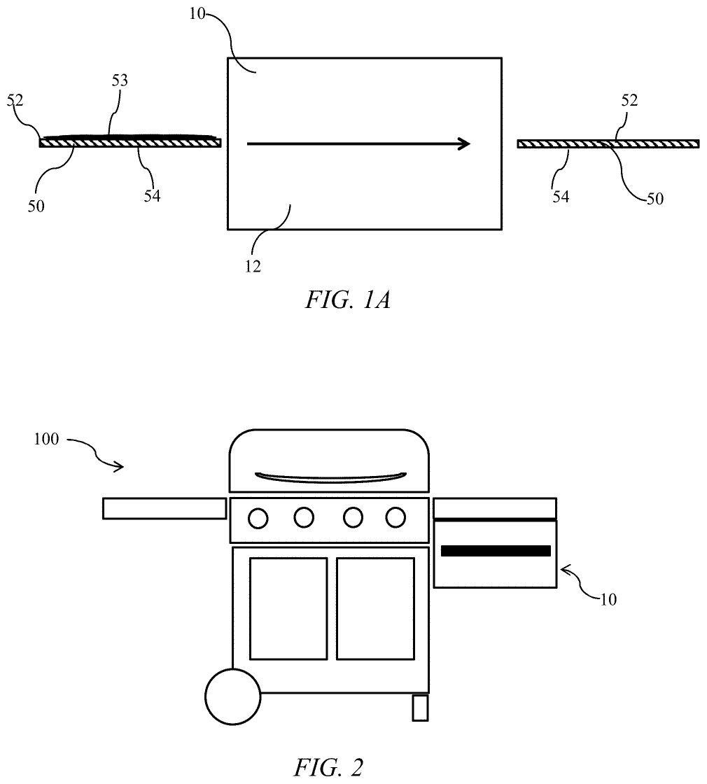

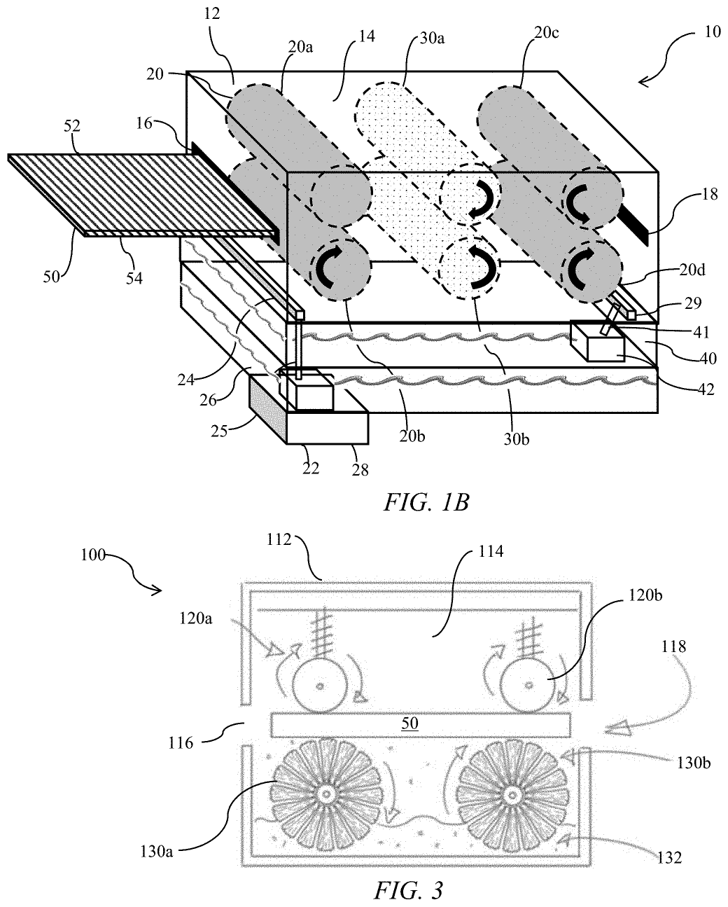

Now referring to the figures, FIGS. 1A-1B illustrate an improved automated cleaning device 10 and system for easily cleaning the cooking grate 50 of a barbeque grill. The cleaning device 10 can be a stand-alone item (as illustrated in FIGS. 1A and 1B) and/or may be incorporated on and/or attached to a barbeque grill itself (as illustrated in FIG. 2) and/or attached to a modular cart for transport and use (as illustrated in FIG. 14), as described in more detail below.

FIG. 1A is a perspective view of a general embodiment of the cleaning device 10 generally having a rectangular shape about the same length or slightly shorter than the length of the standard barbeque grate 50. The cleaning device 10 can be constructed from a variety of corrosive resistant, durable, lightweight materials. As illustrated in FIG. 1A, the grate 50, having a top surface 52 and a bottom surface 54, may have material 53, such as food residue or the like, on a top surface 52 (or a bottom surface 54). The grate 50 may be fed into the cleaning device 10 into a chamber 12 for cleaning, as described in more detail below with respect to FIGS. 1B and 3-5. The grate 50 may exit an opposite side of the chamber 12, as shown in FIG. 1A.

Referring to FIG. B, there is shown a sectional view of the cleaning device 10 of the present disclosure in an exemplary embodiment thereof. The device 10 includes a chamber 12 having an interior space 14. The chamber includes a first opening 16, which serves as an entry into the interior space 14, and an opposing second opening 18, which serves as the exit from the interior space 14. The first opening 16 and second opening 18 are configured for receiving a standard size barbeque cooking grate 50, positioned horizontally for entry into the chamber. In this manner, both the top surface 52 and underside surface 54 of the grate 50 are accessible for cleaning within the chamber 12.

Incorporated within the interior space 14 of the chamber 12 is a plurality of horizontal rollers 20a-20d. The rollers 20a-20d can be constructed from any suitable non-corrosive material. The rollers 20a-20d have a length spanning the width of the interior space 14 of the chamber 12. The rollers 20a-20d can be provided in any number and in various arrangements within the interior space 14, with the presumption that at least two opposing rollers 20a, 20b are positioned near the first entry opening 16 and a second set of opposing rollers 20c, 20d are positioned near the second, exit opening 18. Preferably, the individual rollers 20a-20d are positioned opposing each other, one near the top of the interior space 14 and one near the bottom of the interior space. The rollers 20a-20d are rotated using a power source, such as a 20V angle motor 22, although it should be noted that the rollers 20a-20d may be powered via any power source, such as standard AC or DC power, as apparent to one of ordinary skill in the art.

After the grate 50 is initially placed within the first entry opening 16 to the chamber 12, the first set of opposing rollers 20a, 20b rotate and engage the grate 50 between them, specifically both the top 52 and underside 54 of the grate, to assist in moving the grate horizontally into the interior space 14 of the chamber 12. The first set of rollers 20a, 20b feed the grate 50 into the chamber 12 where it is cleaned as will be described below. After the cleaning process, the grate 50 engages at least a second set of opposing rollers 20c, 20d, which rotate and assist in moving the grate out of the interior space 14 and through the second exit opening 18.

As shown in FIG. 1B, as the grate 50 enters the chamber 12 through the first set of rollers 20a, 20b, the grate 50 is sprayed with a cleaning liquid from at least one sprayer 24 or spray nozzle disposed within the interior space 14 of the chamber 12. It is ideal to have at least one sprayer 24 located near the entry 16 so that the cleaning solution can have time to work on the residue buildup and other undesirable material that may be present on the grate surfaces. The sprayer 24 or sprayers may be positioned on the bottom of the interior space 14 of the chamber 12, on the sides of the interior space and/or on the top surface of the interior space. Preferably, the sprayer 24 or sprayers are positioned to spray the cleaning solution on both the top surface 52 and the underside surface 54 of the grate 50. It should be understood that any number of sprayers 24 may be incorporated into the present device 10.

The cleaning liquid or solution useful in the present cleaning device 10 may be stored in a separate compartment 26 below the chamber 12 and fed to the sprayer 24 or spray nozzle through a hose or tube 25 using a standard pump 28, which may be powered via the power source, as described above. Alternatively, there may be a connection similar to a hose connection, for connecting a separate, stand-alone container of cleaning solution directly to the chamber 12 and sprayer 24 or sprayers. The cleaning solution is ideally a grease cutting formula, such as a dishwashing solution, which is also safe for use on cooking surfaces. It may also be useful to include an antibacterial agent in the cleaning solution.

After the grate 50 enters the interior space 14 of the chamber 12 and is sprayed with the cleaning solution, the grate engages at least one set of cleaning brushes 30a, 30b. The cleaning brushes 30a, 30b are designed as a cylindrical body having a plurality of bristles 32 spaced around the outer circumference of the cylindrical body. Preferably, the cleaning brushes 30a, 30b are provided as an opposing pair, having a similar arrangement to that of the rollers 20, with one brush near the top of the interior space 14, and a second opposing brush near the bottom of the interior space. As with the rollers 20a-20d, the cylindrical cleaning brushes 30a, 30b span the width of the interior space 14 of the chamber 12. Rotation of the cleaning brushes 30a, 30b is accomplished using a power source, such as the 20V angle motor 22 similar to that used to power the rollers 20a-20d. In a preferred embodiment, the cleaning brushes 30a, 30b may rotate opposite of similarly positioned rollers 20a, 20b and 20c, 20d, thereby providing a cleaning action on the grate 50 as the grate 50 is fed therethrough.

Although one set of cleaning brushes 30a, 30b is shown, it should be understood there can be multiple sets of cleaning brushes within the chamber 12, having a variety of arrangements. However, regardless of the number and arrangements, it is preferable to configure the cleaning brushes so that both the top surface 52 and the underside surface 54 of the grate 50 are effectively contacted and cleaned. As shown in the embodiment of FIG. 1B, the set of cylindrical cleaning brushes 30a, 30b is positioned between the first set of rollers 20a, 20b and the second set of rollers 20c, 20d. The rollers 20a, 20b feed the grate 50 to the set of cleaning brushes 30, which in turn, moves the grate along to the second set of rollers 20c, 20d, which in turn move the grate 50 through the exit 18.

When the grate 50 passes between the set of cleaning brushes 30a, 30b, the top cylindrical brush rotates and its bristles 32 effectively clean the top surface 52 of the grate, while the second bottom cylindrical brush rotates and its bristles 32 effectively clean the underside surface 54 of the grate. The rotating action of the cylindrical brushes 30a, 30b, combined with the cleaning solution previously sprayed onto the grate, work to simultaneously clean both the top 52 and underside 54 surfaces of the grate 50. As mentioned, effectively cleaning the entire grate 50, top surface 52 and underside surface 54 is an important advantage of the present disclosure, providing more effective cleaning of the entire grate than traditional cleaning methods, which may result in better cooking results overall.

Once the grate 50 completes its passage through the cylindrical brushes 30a, 30b, and before it exits the chamber 12, it may be important to rinse the grate of the cleaning solution. At least one second sprayer 29 or spray nozzle located before the exit opening 18 is provided as a rinsing sprayer. This sprayer 29 is designed to disperse a water rinse onto the grate 50 as it passes along on the second set of rollers 20c, 20d, or just after passing the second set of rollers and before exiting the chamber. As with the cleaning solution, the water supply may be housed in a separate compartment 40 below the chamber and fed to the sprayer 29 through a tube or hose 41 via a pump 42. Alternatively, the grate 50 may be sprayed with a water rinse after completely exiting the chamber, using a stand-alone source of water.

Although FIG. 1B illustrates an exit 18 through which the grate may exit the chamber 12, it should be noted that the chamber 12 may include only a single opening 16 that may act as both an entrance and an exit. When disposed therein through the opening 16, the grate may be cleaned and rinsed, as described above. The rollers 20a, 20b and/or 20c, 20d may reverse and expel the grate 50 from the chamber 12 through the opening 16. Thus, the grate 50 may be accessible to a user thereby who may feed the grate 50 therein and receive the grate 50 therefrom through the same opening 16.

In one embodiment, the cleaning device 10 may be offered as a free-standing device, and/or may have wheels, a handle or a plurality of handles, or other means for moving the device 10 from one location to another. In another embodiment, as illustrated in FIG. 2, the cleaning device 10 of the present disclosure may be secured or mounted onto the body of a barbeque grill 70. In such an embodiment, the device 10 may be attached to an underside of a side-arm surface of the grill 70 or may be placed in any other location apparent to one of ordinary skill in the art, such as within the storage compartment of the grill (not shown) or in any other location. Moreover, to allow for a more compact cleaning device 10, the grill grates may be sized smaller or narrower than is typically seen so as to be fed within the device 10.

FIGS. 3-11 illustrate various alternate embodiments of the present invention.

Specifically, FIG. 3 illustrates an alternate embodiment of a grate cleaning apparatus 100 comprising a chamber 112 having an interior space 114 with an entry opening 116 and an exit opening 118. Spring-loaded rollers 120a, 120b may extend downwardly from a top of the chamber 112 that may roll in a direction to move the grate 50 therethrough. Thus, because the rollers 120a, 120b are spring-loaded, the apparatus 110 may accommodate thinner or thicker grates, or grates with a large amount or small amount of built-up residue thereon. Cleaning brushes 130a, 130b may rotatably attached to a lower portion of the chamber 112, with a cleaning solution 132 at the bottom thereof. The roller brushes 130a, 130b may rotate through the cleaning solution, thereby picking up cleaning solution as they rotate, and then may engage the surface of the grate 50 as the grate moves through the chamber 112, thereby cleaning the grate 50. Because cleaning brushes may only clean one side of the grate 50, such an embodiment may require a second pass therethrough with the grate flipped over to clean the second side thereof.

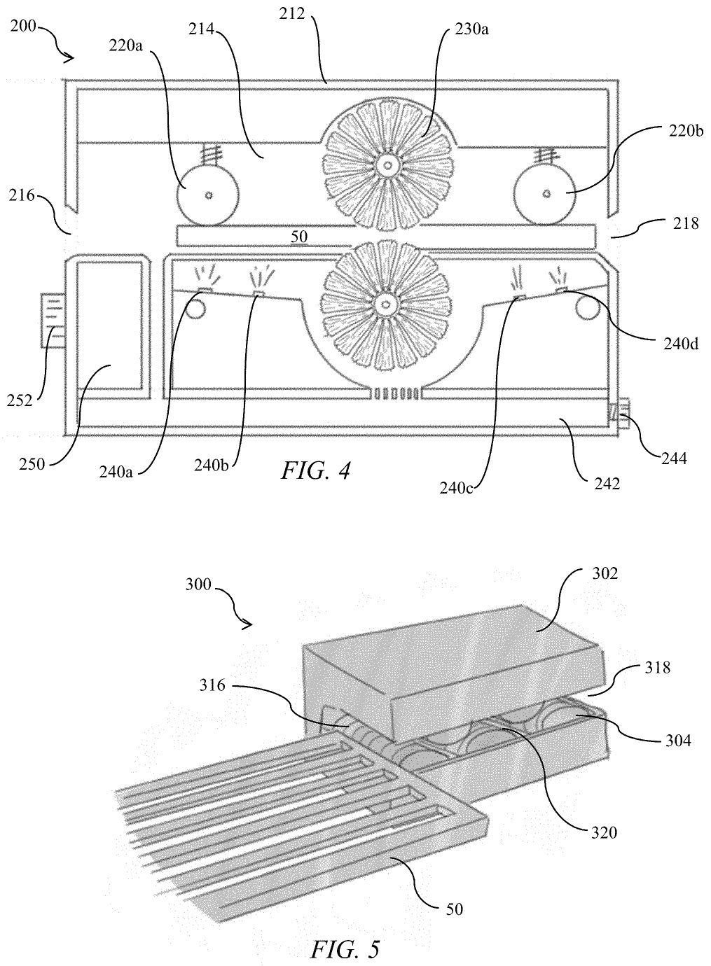

FIG. 4 illustrates another embodiment of the present invention of a grate cleaning apparatus 200 comprising a chamber 212, an interior space 214, an entry opening 216 and an exit opening 218 for moving a grate 50 to be cleaned therein, therethrough, and out of the chamber 212. Rollers 220a, 220b may extend downwardly from the top of the chamber 212 and may rotate to move a grate 50 therethrough. A first cleaning brush 230a may be disposed in a top portion of the chamber 212 and a second cleaning brush 230b may be disposed in a bottom portion of the chamber 212 such that the cleaning brushes 230a, 230b clean opposite sides of the grate 50 as it moves therethrough. Sprayers 240a, 240b, 240c, 240d may be utilized to spray cleaning solution and/or rinsing solution onto the grate as it moves through the chamber 212. For example, sprayers 240a, 240b may spray cleaning solution onto the grate 50 prior to engaging the cleaning brushes 230a, 230b, whereas sprayers 240c, 240d may spray rinsing solution onto the grate 50 after engaging the brushes 230a, 230b to remove residual debris and cleaning solution from the grate 50. Debris and dirty solution may fall to a bottom collection chamber 242 and removed from the apparatus 200 via a plug 244. A vacuum chamber 250 may be included which may include a vacuum port 252 allowing a vacuum to be applied to the interior space 214 of the chamber 212, thereby removing debris and dirty solution therein.

In yet another embodiment, illustrated in FIG. 5, a grate cleaning apparatus 300 is illustrated. The grate cleaning apparatus comprises a C-shaped housing 302 having a plurality of rollers and/or cleaning brushes 304 contained therein, alternately on top and bottom of the housing 302. The housing may have an entry opening 316 and an exit opening 318, and a side opening 320 that allows the grate 50 to be cleaned to be moved through the housing 302 so that the brushes therein clean only a portion of the grate 50 as only a portion of the grate may traverse therethrough. To clean the entirety of the grate 50, the grate may be turned around so that the other portion traverses through the housing 302. As with the other embodiments, the housing may also contain a cleaning solution, sprayers, and other like cleaning elements as apparent to one of ordinary skill in the art.

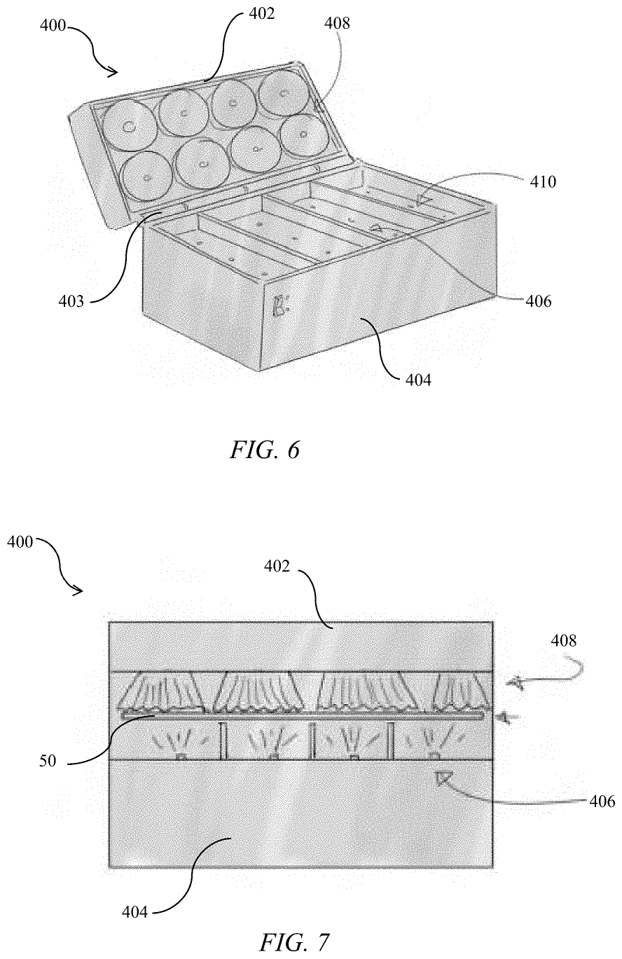

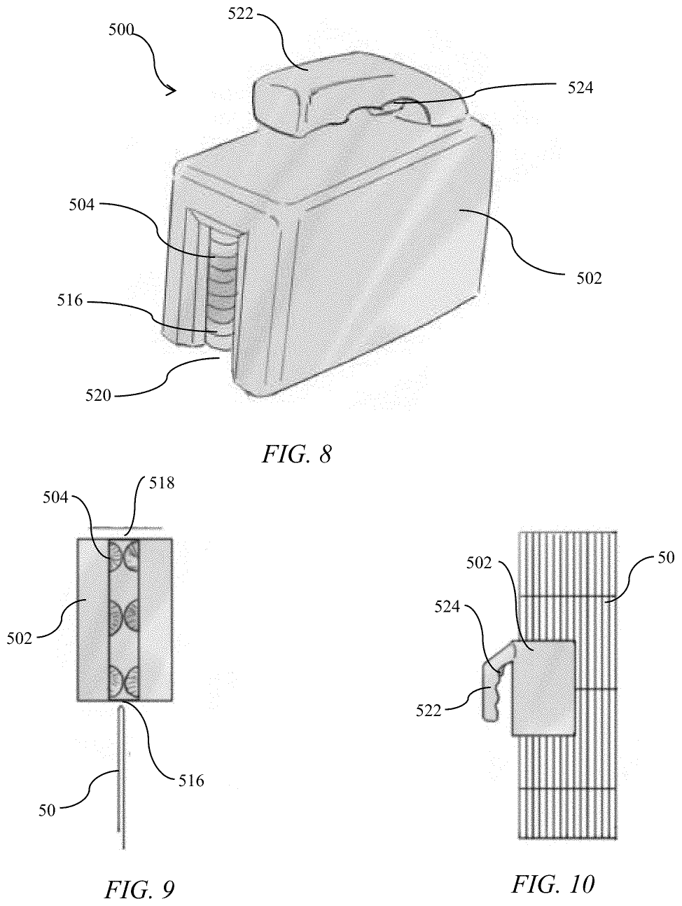

In another alternate embodiment, FIGS. 6-7 illustrate another alternate embodiment of a grate cleaning apparatus 400 comprising a base 402 and a lid 404 with a hinge 403 therebetween. A plurality of sprayers 406 may be disposed within the base 402 and positioned to spray cleaning solution and/or rinsing solution upwardly at a grate 50 that may be contained inside, as illustrated in FIG. 8. A plurality of rotating brushes 408 may be disposed in the lid 402. When a grate 50 is placed within the base 404 over the sprayers 406 and the lid 402 is closed thereover, the sprayers 406 may spray cleaning solution and/or rinsing solution on the grate 50 and the brushes may rotate to clean the top surface of the grate 50. When finished, the grate 50 may be turned over to clean the opposite side thereof. Chambers may be contained within the base so collect debris and dirty solution.

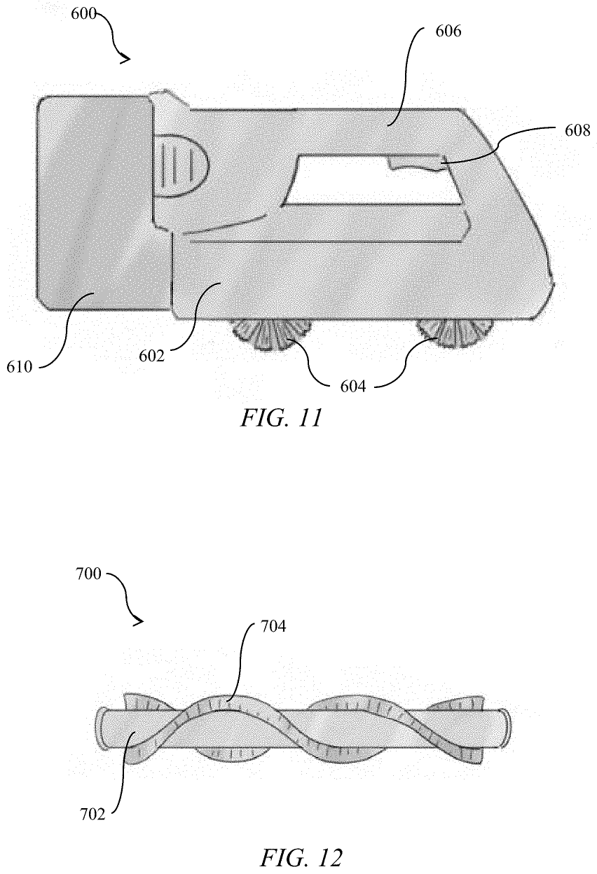

FIGS. 8-10 illustrate an alternate embodiment of the present invention of a hand-held grate cleaning apparatus 500 comprising a housing 502, and entry opening 516, an exit opening 518, a side opening 520, similar to the C-shaped housing 302 described above with reference to FIG. 6. A plurality of rotating brushes 504 may be contained therein forming a path for a grate 50 to traverse. The apparatus may further have a handle 522 and a trigger 524 for selectively activating power, which may be powered via battery or AC power. As illustrated in FIG. 11, the apparatus 500 may be manually moved over a portion of a grate 50. To clean both sides of the grate 50, the grate may be turned around or the apparatus 500 brought to the other side of the grate and manually moved over the surface 50 of the grate. Of course, solutions, such as cleaning or rinsing solutions, may also be contained within the housing, and applied to grate as needed.

FIG. 11 illustrate another embodiment of a hand-held grate cleaning apparatus 600 comprising a housing 602, a plurality of rotating cleaning brushes 604, a handle 606 and a trigger 608. The apparatus 600 may be battery-powered, requiring a changeable battery compartment 610. Of course, the apparatus 600 may be powered using AC power with a cord. In use, the apparatus 600 is hand-held, and placed on a surface of a grate to be cleaned. The user may activate using the trigger 608 thereby starting rotation of the brushes 604. Solutions may be sprayed onto the grate for cleaning and/or rinsing as needed.

FIG. 12 illustrates an embodiment of a rotating brush 700 that may be particularly useful for the present invention, having an axis 702 and one or more brush elements disposed in and around the axis 702 in a spiral pattern or other like pattern. Alternatively, the rotating cleaning brushes used in the present invention may have a plurality of different bristles of varying heights to more effectively cleaning the bars on a grate and/or the spaces around the bars on a grate. For example, a cleaning brush may have a pattern thereon of shorter bristles where the bristles may contact a bar on a grate, and further the cleaning brush may have longer bristles where the bristles may interact with spaces between the bars on a grate, thereby more effectively cleaning the grate.

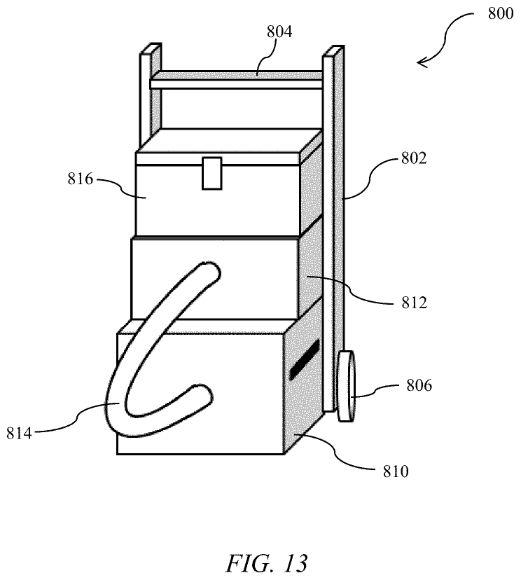

In another embodiment of the present invention, the cleaning device apparatuses disclosed herein may be portable as part of a portable tool cart 800 as illustrated in FIG. 13. The portable tool cart 800 may have a frame 802, a handle 804 and a plurality of wheels 806 for moving the cart from one location to another. The cart 800 may be modular, allowing for various tools to be added and removed as needed. For example, as shown in FIG. 13, a grate cleaning apparatus 810 of the present invention, as described above, may be disposed and attached to the cart 800 on a bottom thereof. A vacuum device 812 may sit stop the cleaning apparatus 810 and may have a hose 814 running from the vacuum device 812 to a location on the cleaning apparatus 810 to enable cleaning of debris from within the cleaning apparatus 810 when in use or thereafter. Specifically, as the cleaning apparatus 810 removes debris from the grill grate fed thereinto, the vacuum device 812 may be activated and pull the debris through the hose 814 and into the vacuum device 812, whereupon it may be filtered and removed. The vacuum hose 814 may be placed in any location allowing for the removal of debris from the cleaning apparatus 810, and the present invention should not be limited as described herein and shown in FIG. 13. Disposed atop the vacuum device 812 may be a toolbox 816 having various tools therein that may be useful for cleaning and repairing barbeque grills or for any other purpose.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. An apparatus for cleaning a cooking grate of a barbeque grill comprising:
a chamber for receiving a cooking grate, the chamber having an interior space for receiving a cooking grate; and
a first cleaning brush within the chamber,
wherein the first cleaning brush is configured to contact and clean at least one surface of the cooking grate within the chamber.

2. The apparatus of claim 1 wherein the first cleaning brush rotates.

3. The apparatus of claim 1 further comprising:
an entry opening on a first side of the chamber, wherein the cooking grate is configured to enter the chamber through the entry opening.

4. The apparatus of claim 3 further comprising:
an exit opening on a second side of the chamber opposite the first side of the chamber, wherein the cooking grate is configured to exit the chamber through the exit opening.

5. The apparatus of claim 1 wherein the first cleaning brush is configured to clean the cooking grate as the cooking grate is disposed within the chamber.

6. The apparatus of claim 1 further comprising:
a second cleaning brush within the chamber.

7. The apparatus of claim 6 wherein the first cleaning brush is disposed beneath the cooking grate as the cooking grate is disposed within the chamber and wherein the second cleaning brush is disposed above the cooking grate as the cooking grate is disposed within the chamber.

8. The apparatus of claim 6 wherein the first cleaning brush and the second cleaning brush are disposed adjacent each other on the same side of a cooking grate as the cooking grate passes through the chamber.

9. The apparatus of claim 1 further comprising:
a roller for moving the cooking grate through the chamber.

10. The apparatus of claim 9 wherein the roller rotates in a direction to move the cooking grate through the chamber, and wherein the first cleaning brush rotates in a second direction opposite the roller.

11. The apparatus of claim 1 further comprising:
at least one sprayer or spray nozzle disposed within the chamber for discharging cleaning liquid onto the grate as the cooking grate is disposed within the chamber.

12. The apparatus of claim 11 further comprising:
a cleaning solution sprayed from the at least one sprayer or spray nozzle onto the cooking grate as the cooking grate is disposed within the chamber.

13. The apparatus of claim 11 further comprising:
a rinsing solution sprayed from the at least one sprayer or spray nozzle onto the cooking grate as the cooking grate is disposed within the chamber.

14. The apparatus of claim 1 further comprising:
a first sprayer or spray nozzle disposed within the chamber;
a second sprayer or spray nozzle disposed within the chamber,
wherein the first sprayer or spray nozzle is configured to spray a cleaning solution onto the cooking grate as the cooking grate is disposed within the chamber, and the second sprayer or spray nozzle is configured to spray a rinsing solution onto the cooking grate as the cooking grate is disposed within the chamber.

15. The apparatus of claim 1 further comprising:
a cleaning solution within the chamber.

16. The apparatus of claim 15 wherein the first cleaning brush rotates within the cleaning solution and moves the cleaning solution to the cooking grate as the cooking grate is disposed within the chamber.

17. The apparatus of claim 1 further comprising:
a collection chamber configured to collect material cleaned from the cooking grate.

18. The apparatus of claim 1 further comprising:
a vacuum hose connected to the chamber, wherein the vacuum hose is configured to be connected to a vacuum for removing material from the chamber.

19. The apparatus of claim 4 further comprising:
a side opening in the chamber, wherein the side opening is configured to allow a portion of a grate to pass through the entry opening and the exit opening.

20. The apparatus of claim 1 wherein the chamber is defined by a base, a lid and a hinge between the base and the lid, wherein the cooking grate sits between the lid and the base when cleaned therein.
